(19) United States
(12) Patent Application Publication
(10) Pub. No.: US 2005/0198448 A1
(43) Pub. Date: Sep. 8, 2005

(54) Self-administered shared virtual memory device, suitable for managing at least one multitrack data flow

(76) Inventors: Benoit Fevrier, Toulouse (FR); Christophe Monestie, Toulouse (FR)

Correspondence Address: YOUNG & THOMPSON, 745 SOUTH 23RD STREET, 2ND FLOOR, ARLINGTON, VA, 22202, US

(21) Appl. No.: 11/065,092

(22) Filed: Feb. 25, 2005

Related U.S. Application Data
(60) Provisional application No. 60/548,100, filed on Feb. 27, 2004.

(30) Foreign Application Priority Data
Feb. 25, 2004 (FR) 04.01889

(51) Int. Cl. H04N 9/44

(52) U.S. Cl. 711/154; 711/170

(57) ABSTRACT

The invention concerns a device comprising a virtual RAM area (4, 5), which is reserved and dedicated to the processing of multitrack flows, comprising a switcher process (27) defining at least one memory line, and multiple flow management processes (PGF1-PGF5), creating or using at least one synchronized buffer in at least one memory line. An administration module (32) synchronizes the successive use of the synchronized buffers of each memory line by the various active processes, as a function of the use sequence which the switcher process (27) determines.

The invention concerns a self-administered shared virtual memory device.

A virtual memory consists of an area of RAM which is associated with one or more microprocessors on a motherboard of the central unit of a device. This virtual memory is organized in blocks of memory which can be used dynamically by at least one application program and/or tasks or processes, in addition to the RAM area(s) which is/are used by the operating system and BIOS.

An application program is a program for a human user, to implement functions (IT or other) which the user chooses. Some application programs, particularly in the audiovisual field, use or generate data flows, called multitrack flows, comprising multiple tracks which are read and/or written and/or modified in parallel. Processing these data flows can require a significant volume of memory, and they can be of very varied formats depending on the applications, and require synchronization between the tracks.

It is becoming evident that there is a need to have available a device which is suitable for managing a significant number of such multitrack flows, in parallel, without filling the RAM of the device.

For example, it would be useful to be able to read and/or transfer from one peripheral to another, and/or to modify (filter, convert, convert from one code to another, encapsulate, extract, etc.), audiovisual multitrack flows of any format such as MPEG, MPEG2, DV, audio, etc., without necessitating any specific configuration of the required virtual memory and without the risk of filling or blocking this virtual memory. Other applications also necessitate the processing of high-volume multitrack data flows in parallel. For example, in the petroleum industry, numerous seismic surveys are carried out, and they form the data flows which must be compared with model files.

IT devices which use a shared virtual memory are already known.

To allocate virtual memory to an application program, for example, a function such as “malloc (size)” in the C language or “new [size]” in the C++ language is used. This creates a block of virtual memory which is accessible only by the process which uses this function. Libraries of known system functions such as “shmat” or “shmcreat” in the C language make it possible to have the same area of virtual memory shared by multiple processes, which therefore target a known initial address of virtual memory. Synchronization is then carried out using semaphores or mutual exclusion (“mutex”) mechanisms, in such a way that the various processes access the shared memory with an address which is offset from the start address. But these synchronization mechanisms assume, for each process, that the various tasks which the various processes carry out, and the formats of the data which is used in virtual memory, are known and precisely taken into account. Additionally, the allocation of memory blocks is rigid. EP-1 031 927 describes a method of allocating blocks of shared memory to different tasks (processes), consisting of identifying and allocating available blocks in memory for each task via tokens and a single allocation table. This method is nevertheless independent of the application programs, and does not take account of their specific constraints. Thus in particular it is unsuitable for processing multitrack data flows such as audiovisual flows.

No known device makes it possible to manage a self-administered, and thus self-adapting, shared virtual memory area, which would enable it to be used dynamically for processing multitrack data flows of any format, not necessarily specified in advance, and in any number.

The invention is aimed at solving this general problem.

More particularly, the invention is aimed at proposing a device which is particularly suitable for processing audiovisual multitrack flows.

The invention is also aimed more particularly at proposing a device in which the management of the self-administered virtual memory area is ensured directly and fully automatically, application programs not having to deal with the problems of memory addressing, synchronization between the functional processes, and parallel processing on various parts of this self-administered virtual memory area.

The invention is also aimed more particularly at proposing a device which makes it possible to implement different kinds of processing (reading, writing, transfer, conversion, filtering, conversion from one code to another, compression, decompression, encapsulation, extraction, etc.) in parallel and simultaneously.

The invention is also aimed at proposing a device in which the management of the self-administered virtual memory area makes it possible to absorb the differences between reading or writing rates of media or peripherals.

In this view, the invention concerns a device comprising:
means with microprocessor(s) and RAM(s), which are suitable for executing at least one operating system and at least one data processing application program,
at least one virtual RAM, which is suitable for use as working RAM for at least one application program, of which at least one is suitable for processing at least one flow of digital data, called a multitrack flow, comprising multiple tracks which are read and/or written and/or processed in parallel,
   wherein:
a) it comprises means, called configuration means, which are suitable for configuring the device with:
   a virtual memory area, called the self-administered memory, which is reserved and dedicated to the processing of multitrack flows, this self-administered memory comprising an administration area which is dedicated to the administration of the self-administered memory, and a useful area for processing the data,
   a functional process, called the switcher process, which is suitable for being loaded into RAM, and for defining and recording in the administration area at least one memory line which is intended to contain a list of buffers, called synchronized buffers, of the useful area of the self-administered memory,
   multiple functional processes, called flow management processes, which are suitable for being loaded into RAM, and, with at least one memory line, for creating and/or using at least one synchronized buffer in this memory line, for executing at least one task on the data of a multitrack flow, and then for releasing this/these synchronized buffer(s),
b) the switcher process is suitable for:
   determining, as a function of predefined processing constraints for each multitrack flow to be processed, a sequence for using the synchronized buffers of at least one memory line by each flow management process, called an active process, which is involved in the processing of the said multitrack flow,
   transmitting to each active process data identifying the memory line(s) in which it must create and/or use at least one synchronized buffer,
c) the device includes an administration module, which is suitable for synchronizing the successive use of each synchronized buffer of each memory line by the active processes, as a function of the use sequence which the switcher process determines.

The invention also makes it possible to process in parallel and simultaneously (on the same time line) completely different multitrack flows, which until now have been considered completely incompatible with each other, for example a track in high-definition video format without compression and a video track in a highly compressed format such as MPEG2 format. This result is obtained by means of the self-administered memory, the switcher process, the flow management processes and the various memory lines, which make it possible to synchronize the data and schedule the various flow management processes, which can execute numerous different tasks on the data.

Advantageously and according to the invention, the administration module is linked (at compilation and execution) to the switcher process and to each flow management process, and combines the common management functions of the self-administered memory. According to the invention, this administration module is advantageously formed from a library of common functions which are linked (in the IT sense) to the processes by object-oriented programming, for example as a dynamically linked library in the C++ language.

As well as making it possible to schedule flow management processes to use the synchronized buffers of a memory line, the administration module comprises other common functions.

In particular, advantageously and according to the invention, the administration module is suitable for determining, when a synchronized buffer is released by a flow management process, the subsequent flow management process which is defined in the use sequence, and if none is defined, for deleting the synchronized buffer. Deleting the synchronized buffer makes the corresponding memory space available again for other processing. It should be noted that the synchronized buffers which are created on the same memory line do not necessarily correspond to contiguous fragments of the useful area of the self-administered memory.

Advantageously and according to the invention, each flow management process is suitable for processing the data at each instant with a single synchronized buffer of one memory line, and then for releasing this synchronized buffer at the end of processing. The various synchronized buffers of a memory line are used in succession by each flow management process, one after the other. Consequently, the use of the space of the useful memory is optimized, and several flow management processes can be active simultaneously on different synchronized buffers, in a perfectly synchronized way.

Additionally, advantageously and according to the invention, the administration module includes the following functions:
creating the administration area and useful area of the self-administered memory,
initializing a memory line with a maximum rate of filling the useful area by this memory line,
creating a synchronized buffer in a memory line,
releasing a synchronized buffer,
access to a synchronize buffer by an active process,
determining the subsequent active process in the use sequence of a synchronized buffer of a memory line, after the synchronized buffer has been released by the previous active process.

Additionally, advantageously and according to the invention, the switcher process is suitable for defining, for each track of each multitrack flow to be processed, at least one memory line which is dedicated to the processing of this track. Additionally, advantageously and according to the invention, the switcher process is suitable for defining, for each track of each multitrack flow to be processed and for each flow management process which processes the data of this track, at least one source memory line which supplies data to be processed by the flow management process, and/or at least one destination memory line which receives the data which the flow management process has processed.

Additionally, advantageously and according to the invention, the switcher process is suitable for defining one and only one use sequence for all the synchronized buffers of the same memory line.

Additionally, advantageously and according to the invention, the switcher process is suitable for transmitting the use sequence of each memory line to the first flow management process which must be active on a synchronized buffer of a memory line. This flow management process is the creator of this synchronized buffer, and defines and records, in the administration area, data which identifies this synchronized buffer and associates it with the memory line and use sequence.

Additionally, advantageously and according to the invention, the switcher process is suitable for calculating, as a function of the nature of each multitrack flow to be processed, a maximum size of the useful area of the self-administered memory which can be given to each memory line. In this way, the use of the useful area of the self-administered memory is optimized by the switcher process according to the requirements of each track of each multitrack flow, with no risk of blocking. This maximum size is advantageously defined in the form of a filling rate, for example a percentage, of the useful area of the self-administered memory. It is recorded in the administration area.

Additionally, advantageously and according to the invention, the flow management processes are distinct, and each of them carries out at least one task which belongs to it. On the other hand, there is nothing to prevent providing that multiple identical versions of one or more flow management processes are active simultaneously, in particular to implement similar tasks in parallel.

In an advantageous embodiment of the invention for many applications of the device, the device includes at least one application program, called the launcher module, which is suitable for loading into RAM the various processes and modules which make the configuration and functioning of the self-administered memory possible, including:
the switcher process,
each flow management process which is liable to be used for processing multitrack flows,
the administration module,
a module for dynamic windowing on a display screen of the device. This is suitable for forming a human/machine interface which enables a user to define each multitrack flow to be processed from source data with various origins. In this variant, it is the loading into memory of the launcher module, on the command of a human user, which makes it possible to configure the device with the self-administered memory, the flow management processes, and the switcher process, in conformity with the invention. The windowing module is an application program which enables the user to operate the thus configured device according to the invention in a simple, user-friendly way, in particular by commands of click/drag type on source data files which are intended to form the multitrack flow(s).

In another variant, which can also be combined with the previous one, the device according to the invention can be configured in advance, from its startup for example, and function more or less automatically, in particular as a slave within a complex architecture (e.g. within a network), or on command from an automatic control application program to execute certain tasks according to predetermined events (e.g. to assemble, convert and record on a recording unit multiple tracks which are read from different external sources). In this variant, the dynamic windowing module is not indispensable.

Advantageously and according to the invention, the device comprises:
at least one flow management process, called the loading process, which is suitable for writing data—in particular data from a read unit—into the useful area of the self-administered memory,
at least one flow management process, called the process which is suitable for reading data—in particular data which is intended for a reception unit such as a recording device, display screen, etc.—from the useful area of the self-administered memory.

A read unit can be a peripheral of the device according to the invention, another device, or any device which is liable to output data which is intended for the device according to the invention.

Similarly, a reception unit can be a peripheral of the device according to the invention, e.g. a recording device, another device, or any device which is liable to receive data which the device according to the invention outputs.

Additionally, advantageously and according to the invention, the flow management processes are suitable for being loaded into a RAM area which is distinct from the self-administered memory. Similarly, the switcher process is suitable for being loaded into a RAM area which is distinct from the self-administered memory.

Additionally, advantageously and according to the invention, the switcher process is suitable, in a first analysis phase, for analyzing the characteristics of each multitrack flow to be processed and the processing constraints of each multitrack flow, in such a way as to define the data representing the memory lines and the data representing each use sequence of the synchronized buffers of each memory line for processing this multitrack flow, and then, in a second, subsequent processing stage, for launching the processing of the multitrack flow according to the said data, which was defined in advance in the analysis phase.

The predefined constraints associated with each flow can be predefined by programming the switcher process, and/or recording parameters in a mass memory of the device, and/or by data, called metadata, which is associated with the flow —in particular in a header—and read by the switcher process and/or supplied by the application program. These constraints include, for example, the number of tracks; the synchronization data between tracks; the duration of each track; the rate of transfer of data from/to a read unit/reception unit; the format of the data on each track; the data compression method; the nature of the processing to be carried out on each track; etc.

Advantageously, in a device according to the invention, the size of the self-administered memory is defined by the configuration means at a predetermined fixed value—in particular between 20% and 80% of that of the virtual memory, typically of the order of 128 megabytes to 15 gigabytes with present-day memories. Similarly, advantageously and according to the invention, the size of the administration area is defined by the configuration means at a predetermined fixed value—in particular an absolute fixed value, for example of the order of 1 megabyte. The size of the administration area is much less than that of the useful area of the self-administered memory. Additionally, advantageously and according to the invention, the self-administered memory is defined by the switcher process when it is loaded into RAM.

Additionally, advantageously and according to the invention, in the administration area each element, called an administration element, contains an address of a previous element and an address of a following element.

Advantageously and according to the invention, the administration area comprises, at the processing stage:
a list of available self-administered memory fragments,
a list of active memory lines (i.e. defined by the switcher process),
a list of those synchronized buffers of the useful area of the self-administered memory which the active memory lines must use, and a list of the various active processes which must use these synchronized buffers of the self-administered memory.

Advantageously and according to the invention, the configuration means are suitable for allowing the processing of multitrack flows which are audiovisual flows, in particular those having tracks of which the format is chosen from:
high-definition television formats (TVHD),
standard-definition television formats (TVSD),
digital cinema formats,
compressed video formats (MPEG2, MPEG4, DV, etc.),
non-compressed audio formats,
compressed audio formats,
multitrack encapsulation formats (Quicktime®, AVI®, etc.),
picture formats,
raw audiovisual data formats.

The invention extends to a recording medium which is liable to be read by a read unit associated with a digital processing device. This recording medium comprises a computer program which is suitable for forming configuration means of a device according to the invention, when it is installed and executed on this device.

The invention extends to a method of processing multitrack flows using a device according to the invention.

The invention also extends to a device, a recording medium, and a method with all or some of the characteristics which are mentioned above or below.

Other objects, characteristics and advantages of the invention will appear when the following description, which is given as an example only and is not restrictive, is read. It refers to the attached figures, in which:

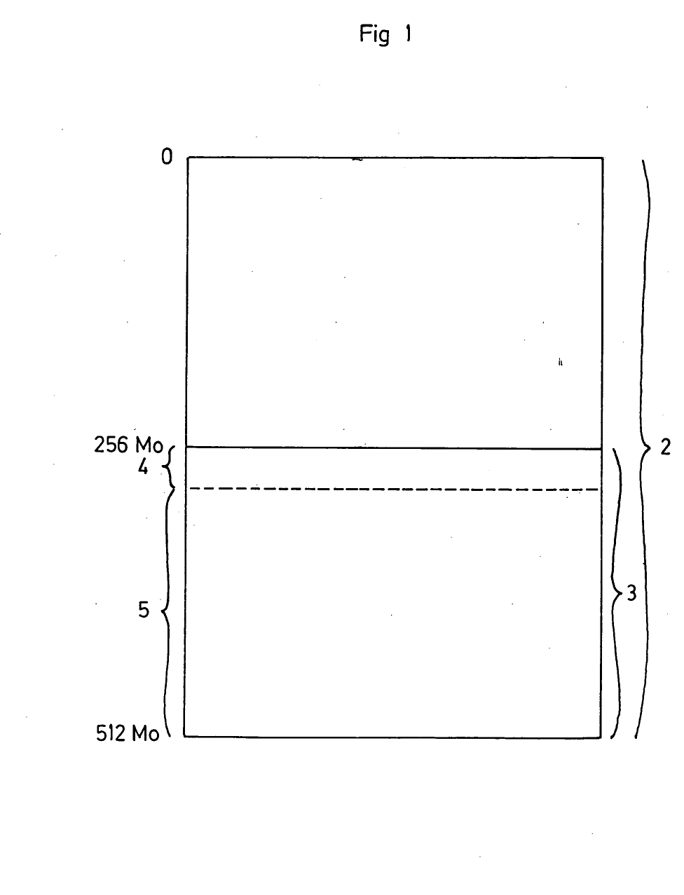

FIG. 1 is a diagram representing the organization of a RAM of a device according to the invention,

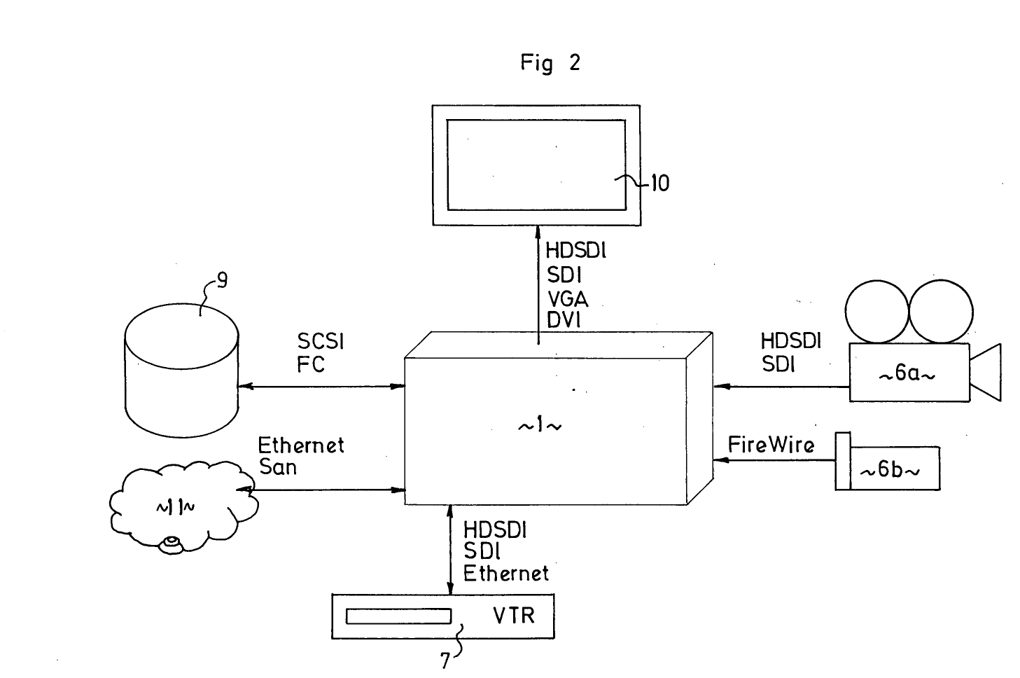

FIG. 2 is a diagram of an example of the environment of peripherals which can be advantageously operated with a device according to the invention,

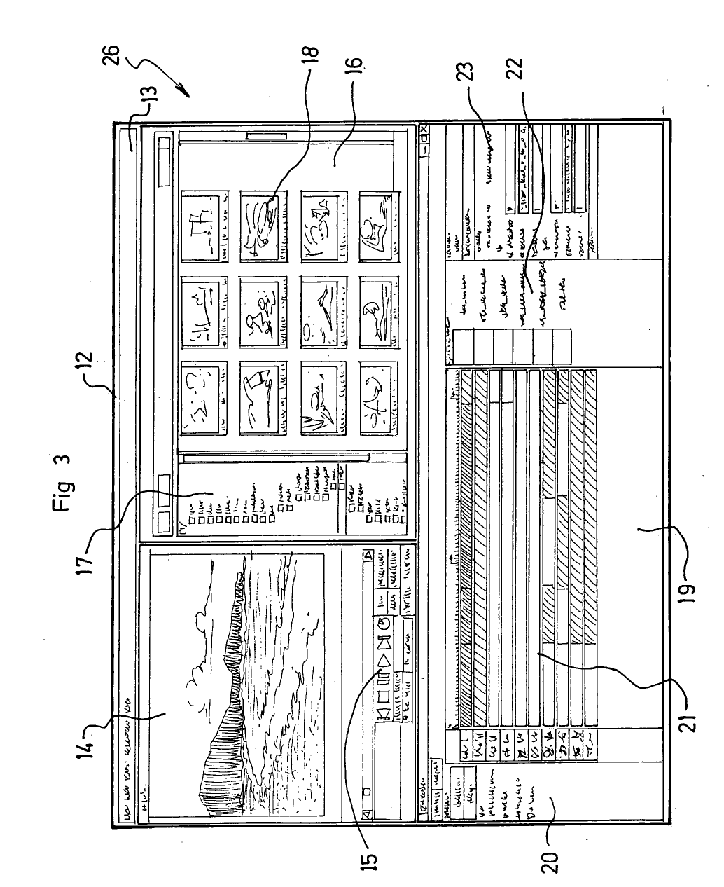

FIG. 3 is a diagram of an example of a window of a human/machine interface which is activated by a launcher module of a device according to the invention,

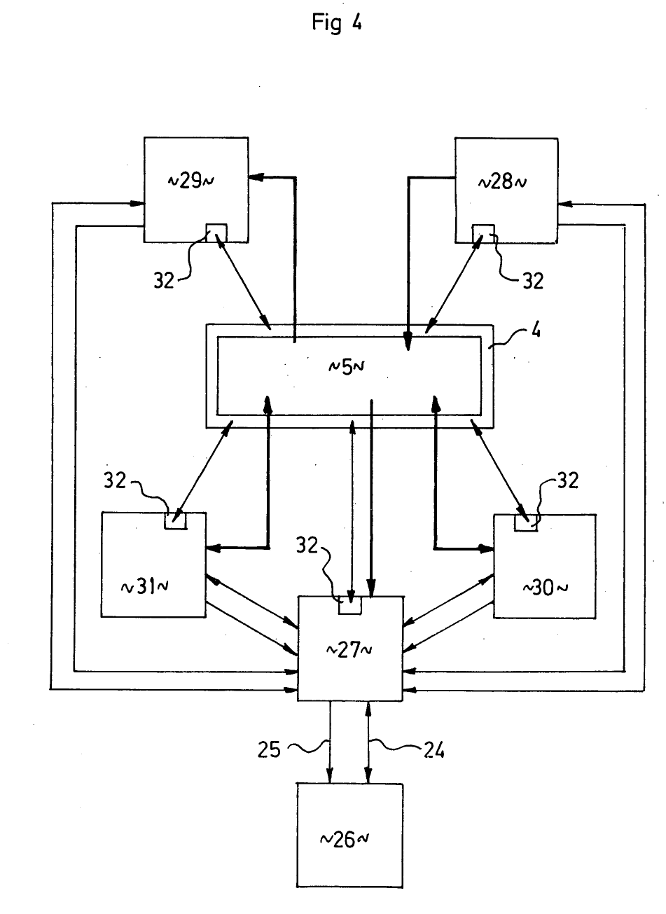

FIG. 4 is a diagram showing an example of the functional IT architecture of a device according to the invention,

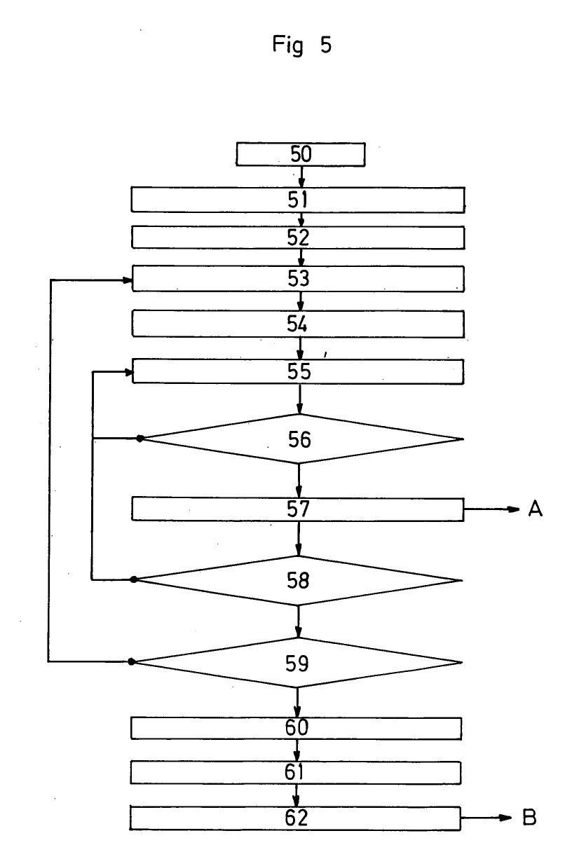

FIG. 5 is a flowchart showing an example of an algorithm of a switcher process of a device according to the invention,

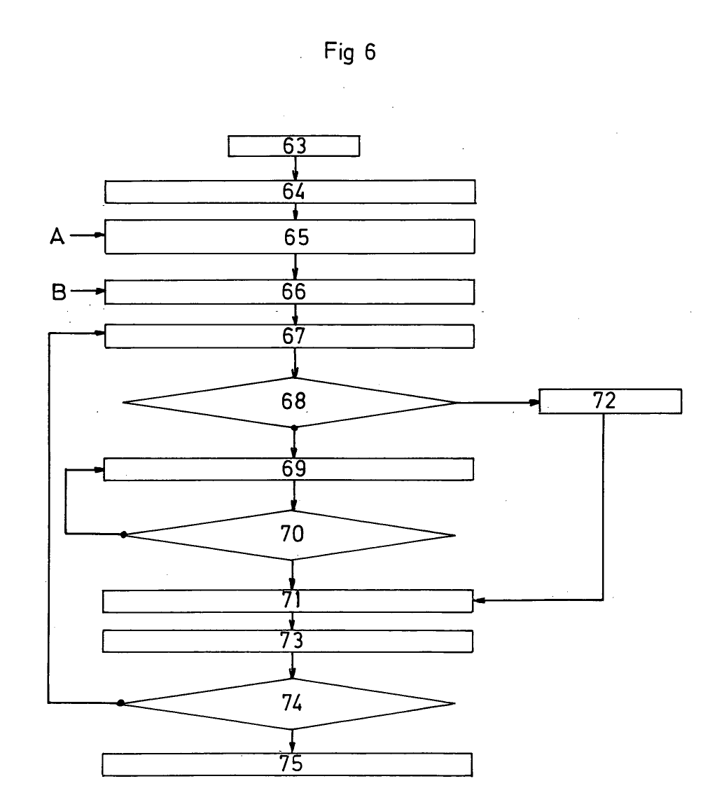

FIG. 6 is a flowchart showing an example of an algorithm of a flow management process of a device according to the invention,

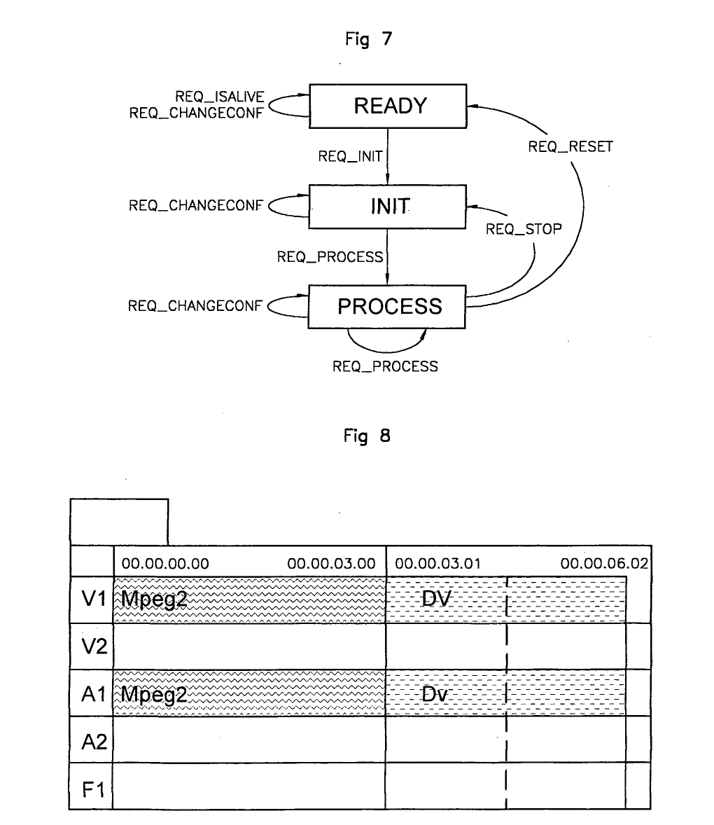

FIG. 7 is a diagram showing the general architecture of the requests and states of the flow management processes of a device according to the invention,

FIG. 8 is a diagram showing an example of a timing diagram of two multitrack flows which must be processed in succession,

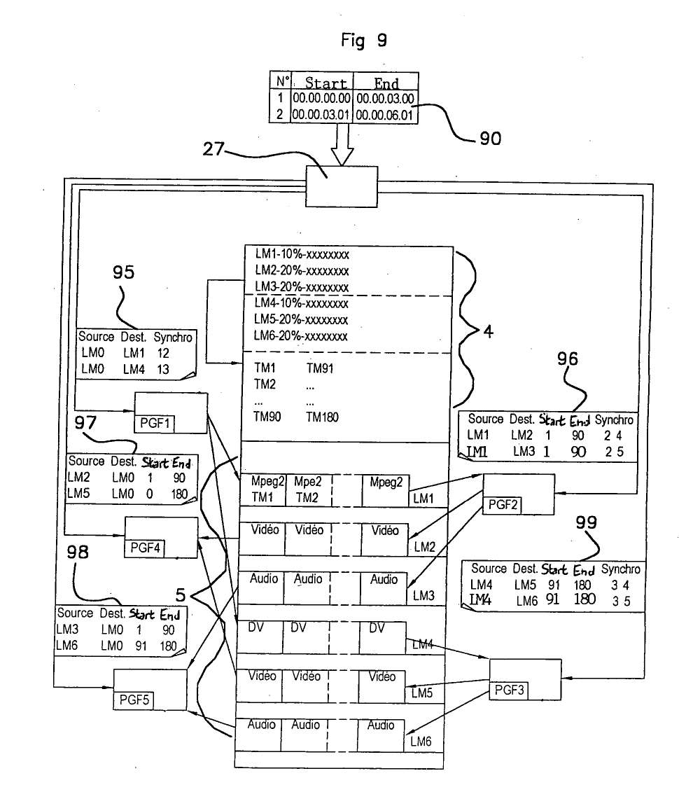

FIG. 9 is a diagram showing the organization of the functioning of the self-administered memory of a device according to the invention for processing the flows of FIG. 8.

A device 1 according to the invention is a device for processing digital data, which from the point of view of its structural architecture can be implemented in all known possible forms. It can be a microcomputer comprising a motherboard with one or more microprocessors and associated RAM; one or more buses for connecting straps for memory and/or peripherals (in particular a human/machine interface comprising a keyboard, a pointing device and a display screen); and mass memories such as a hard disk and/or readers/recorders of removable mass memory media. It can also be a network architecture, comprising multiple machines and/or parts of machines which are connected to each other. In any case, the device according to the invention is suitable for forming at least one central unit, making it possible to execute at least one operating system (in particular of LINUX®, UNIX®, WINDOWS® etc. type) and one or more data processing application programs.

The device according to the invention also comprises at least one virtual memory 2, which is suitable for use as working memory for application programs.

A virtual memory is actually a RAM area which is managed centrally by at least one module of the operating system, and which can be made available to at least one application program to enable it to carry out specific tasks.

In FIG. 1, an example of virtual RAM 2 is shown. This virtual memory 2 can be a portion of RAM which is associated with a microprocessor on a computer motherboard. It should be noted that the invention applies equally well to the implementation of such a virtual memory with the RAM implemented in other forms, for example a RAM which is associated with a microprocessor via a bus. The implementation technology of this RAM is actually unimportant in the context of the invention, provided that the capacities and access speeds and other characteristics of the hardware memory which implements this RAM are compatible with its applications, in particular in terms of duration of processing. In particular, it should be noted that for processing audiovisual multitrack flows, particularly reading them, the processing durations in RAM must be short enough to avoid any interruption of the reading of the audiovisual flow, or any chopping or jerking phenomenon.

In a device according to the invention, a predetermined portion of the virtual memory 2 can be reserved and dedicated to the processing of multitrack flows. This specific area, called the self-administered memory 3, can be defined in advance, e.g. by configuration by the user, either in the form of a fixed value or by a value corresponding to a percentage of the total virtual memory 2 or the total RAM 1.

In the example shown in FIG. 1, the virtual memory 2 has a capacity of 512 megabytes, and the self-administered memory 3 has a capacity of 256 megabytes.

Additionally, the self-administered memory 3 comprises two distinct areas: namely one area called the administration area 4, which is dedicated to the administration of the self-administered memory 3, and in which data making it possible to administer (organize, synchronize, defragment, etc.) the self-administered memory 3 can be recorded; and one area called the useful area 5, which is used as working memory for processing the flows of digital data, called multitrack flows, comprising multiple tracks which are read and/or written and/or processed in parallel. The size of the useful area 5 is much greater than that of the administration area. The administration data is not data to be processed by the device such as multitrack flow data.

The tracks of the multitrack flow are, for example, a video track, an audio track, etc. In a multitrack flow at the input and/or output, the tracks can be transmitted in a multiplexed format on a single and/or compressed line, e.g. MPEG2, DV, etc. But the processing of a multitrack flow can include at least one task or series of tasks (reading, recording, conversion, conversion from one code to another, filtering, compression, decompression, encapsulation, extraction from an encapsulated format, etc.) to be carried out separately on multiple tracks (the number of which can be very large).

As shown in FIG. 2, the device 1 according to the invention can be used for processing data flows from and/or to various peripherals, with formats which are normally mutually incompatible. In the example shown in FIG. 2, cameras (e.g. of digital cinema, digital video or digital camcorder, etc. type) are provided, which can supply video data via interfaces of HDSDI, SDI, “Firewire” (also called I-link or IEEE1394), or Ethernet type. In the example, a digital cinema camera 6a and a DV camcorder 6b are shown. A video recorder 7 or other reading/recording device, which can acquire and/or supply video data via interfaces of HDSDI, SDI or “Firewire” type or a local network, for example of Ethernet type, is also provided. A mass memory unit such as a disk unit 9, e.g. of RAID type supplying and/or receiving video data, a display screen of VGA type or a video monitor 10 receiving video data by an interface of HDSDI, SDI or analog type, and a link to a network 11 via an interface of Ethernet type or a shared storage network (“SAN”), can also be provided. In this example, the device 1 according to the invention forms a video server.

Obviously, this illustration is only an example, and any other link which supplies or receives multitrack data can be provided, for example a television broadcast receiver (via microwave, satellite or cable, etc.).

The device according to the invention includes at least one application program, called the launcher module, which is suitable for loading configuration means of the device into RAM, and then initiating execution, in conformity with the invention. In particular, this launcher module starts a dynamic windowing module,.which implements, on a display screen of the device, a window 26 such as is shown in FIG. 3, which is suitable for forming a human/machine interface 26, enabling a user to define each multitrack flow to be processed from data with various origins. In the example shown in FIG. 3, the window 26 comprises a title bar 12, a menu bar 13, and a video display window 14, which is associated with an area 15 for commands and displaying information about reading/recording (reverse, rapid reverse, read, pause, stop, rapid forward, forward, counter, etc.). A navigation window 16, comprising an area 17 for displaying the tree structure of files and an area 18 for displaying miniatures or icons representing the files, is also provided.

The window 26 also includes an assembly window 19, comprising a command or action area 20, an area 21 for showing the timing of the multitrack flows to be processed (this is used in the case of editing), an area 22 of filtering tools which the user can activate, and a supplementary area 23 for displaying/entering specific commands. An area (not shown in the example) for managing the acquisition of multitrack flows can also be provided advantageously.

With such a window 26, the user can, for example, simply select a file in the navigation area 16 and move it towards the timing display area 21. The effect of this is to take account of the multitrack flow which is associated with this file in its processing by the self-administered memory 3. In particular, because of the invention, it is possible to associate on the same timing diagram, and to set up simultaneously in a synchronized fashion, different multitrack flows of completely different formats, which are normally incompatible, and in particular high-definition formats, standard-definition formats, compressed or uncompressed formats, encapsulation formats (Quicktime®, AVI®, etc.).

FIG. 4 shows an example of IT architecture corresponding to the configuration means of the self-administered memory 3 in a device according to the invention. This architecture includes the human/machine interface 26 which is shown in FIG. 3.

This human/machine interface 26 communicates with a functional process, called the switcher process 27, which is loaded into RAM 1, and preferably executed on the same machine as that on which the self-administered memory 3 is managed. This switcher process 27 is a functional process, i.e. a process of low-level server type in the operating system, and cannot be seen or accessed directly by the user.

The configuration means according to the invention also include other functional processes, called flow management processes, the number of which is unlimited, each of them being suitable for being loaded into RAM 1 and carrying out at least one task on the data of a multitrack flow. Very many flow management processes can be developed according to the functions to be carried out for the expected application of the device according to the invention. Preferably, each flow management process is suitable for carrying out a single, specific task, or a series of tasks corresponding to a single processing function on one track of a multitrack flow, e.g. reading, recording, transferring to a peripheral such as a display screen, filtering, conversion from one code to another, compression, decompression, encapsulation, extraction from an encapsulated format, etc.

However, it should be noted that the human/machine interface 26 communicates directly and uniquely with the switcher process 27, and in no way with the flow management processes. Consequently, whatever function is required by the application program which is controlled by the human/machine interface 26, this function is necessarily addressed to the switcher process 27 and processed and analyzed by it.

In the non-restrictive example which is shown in FIG. 4, under the heading of flow management processes, the following are provided: a process 28 for loading data into the useful area 5 of the self-administered memory 3, a process 29 for recording data from the useful area 5 of the self-administered memory 3, a process 30 for filtering data which is read in the useful area 5 of the self-administered memory 3 and written back after filtering to the useful area 5 of the self-administered memory 3, and a process 31 for controlling display peripherals. It should be noted that the various flow management processes do not communicate with each other directly, but only communicate with the switcher process 27. Communication between the dynamic human/machine interface window 26 and the switcher process 27 is via two dedicated communication links (e.g. of “SOCKET” type), that is one communication link of command/acknowledgment (CMD/ACK) type 24, and one monitoring link 25 which makes it possible to transmit statuses, time codes and any errors between the switcher process 27 and the dynamic windowing module 26.

Each flow management process 28, 29, 30, 31 is configured by the switcher process 27. Additionally, the various flow management processes 28 to 31 only exchange data corresponding to the content of the multitrack flows, via the useful area 5 of the self-administered memory 3.

Each flow management process 28 to 31 is linked to the switcher process 27 by two communication links (e.g. of “SOCKET” type), that is one command/acknowledgment (CMD/ACK) link and one link for monitoring any errors which are found by the corresponding flow management process 28 to 31.

A common library 32 of IT operations which the flow management processes 28 to 31 and the switcher process 27 use to carry out common commands or tasks via reading/writing in memory is also provided. This library 32 forms a module, called the administration module 32, which is linked by programming to each process 27, 28 to 31. It should be noted that the self-administered memory 3, with the flow management processes 28 to 31, the switcher process 27 and the administration module 32, can function entirely autonomously, without necessitating the execution of dynamic windowing, or more generally of a user graphic interface such as 26.

The various flow management processes 28 to 31 are preferably similar in their functioning and their architecture. This common general architecture is represented by an example in FIG. 7.

The REQ_ISALIVE service enables the human/machine interface 26 to know whether the various flow management processes are or are not loaded and active.

The REQ_INIT service initializes the flow management process and puts it into the “INIT” state, as shown in FIG. 7. It is on receiving this service that all the flow management processes are configured before starting an action on the data to be processed. Each flow management process also has a REQ_CHANGECONF service, which enables the switcher process 27 to change the specific configuration of this flow management process.

REQ_PROCESS designates generically all the actions which are carried out on each multitrack flow by a flow management process which is then in the “PROCESS” state, as shown in FIG. 7.

The REQ_STOP request puts the flow management process into the initialized state. The REQ_RESET request enables the flow management process to go into a stable “READY” state.

The library 32 which forms the administration module includes various common functions which the processes can use, in particular:
a function to create the administration area 4 and useful area 5 of the self-administered memory, consisting of reserving the corresponding RAM areas with their corresponding memory addresses,
a function to initialize, in the administration area 4, a memory line (on command from the switcher process 27), with a maximum filling rate (calculated by the switcher process 27) of the useful area 5 by this memory line,
a function to create a synchronized buffer in a memory line (by a flow management process which creates such a synchronized buffer) with its memory size, its number, its address, its use sequence (list of the various active flow management processes which must access this buffer in succession, as determined by the switcher process 27), and a field recording its current state,
a function to access a synchronized buffer of a memory line by an active flow management process,
a function to release a synchronized buffer after use by a flow management process, so that this synchronized buffer can be made available for the subsequent flow management process, or to delete the synchronized buffer if this is the last active flow management process which must act on this synchronized buffer,
a synchronization function, consisting of determining, after a synchronized buffer is released by an active process, what is the subsequent active process which must act on this synchronized buffer, from the use sequence of this synchronized buffer.

This library 32 can consist of classes which are programmed in the C++ language, for example.

The launcher module loads into RAM, as well as the human/machine interface 26, the switcher process 27, each flow management process 28 to 31, and the library 32 (administration module), these processes 27 to 31 being linked to each other and the library 32.

FIG. 5 shows a flowchart of the functioning of the switcher process 27.

Step 50 represents the initialization of the switcher process 27 and its loading into memory, e.g. by the effect of the startup of the launcher module. In the subsequent step 51, the switcher process 27 creates the self-administered memory 3. It creates a connection to each flow management process 28 to 31. When the user executes a command on the window 26, the switcher process 27 actually receives a sequence of multitrack flow(s) in the form of a timing diagram, conventionally called the “list of editions”. In FIG. 5, this reception is shown as step 52.

Then, in step 53, it analyzes this list of editions and opens a loop on the various editions, i.e. on the various tracks to be processed.

The switcher process 27 records (step 54), in the administration area of the self-administered memory 3, one or more memory lines, in general including at least one source memory line and/or at least one destination memory line. The switcher process 27 creates at least one memory line for each track (source or destination) to be processed. It should be noted that the same memory line can act as source and destination for the data to be processed.

For example, it creates one memory line to receive a source video track and one source memory line to receive an audio track which must be processed in parallel, and/or one or more destination memory lines to receive the result of the processing by the active flow management process.

This analysis step 53 enables the switcher process 27 to define the number of memory lines, the maximum size in memory of each memory line, and the use sequence of the synchronized buffers on each memory line, as a function of the constraints which are predefined by the application program which supplies the multitrack flow to be processed to the switcher process 27. In the example, this application program consists of the human/machine interface 26. In particular, the analysis step 53 is started when the user puts a file into the timing display area 21 using the pointer device, the effect of which is to supply to the switcher process 27 requests and parameters corresponding to the multitrack flow to be processed. On receiving such a request for edition of a multitrack flow, the switcher process 27 firstly determines whether the processing to be carried out consists of edition or on the other hand acquisition.

Edition Case:

As a function of the parameters which the application program 26 transmits, the switcher process 27 determines whether the edition must be filtered and/or displayed and/or recorded, and determines the use sequence of the synchronized buffers for each memory line to be created, corresponding in reality to the action sequence of the various flow management processes which must be active on each track of the multitrack flow.

The parameters which are taken into account are:
a “list of editions” file (edl),
a “list of files” file (edl file),
a “list of filters” file (edl filter).

For each edition, i.e. each track, of the list of editions, the switcher process 27 determines the format of the data, i.e. in particular the audio/video standard in which they are recorded, and determines the size of the edition (i.e. of the track) in relation to the maximum size of the various editions of the sequence, to determine the percentage of the useful area 5 of RAM which can be assigned to each memory line corresponding to each track.

The switcher process 27 then creates one source memory line for each audio track and one source memory line for each video track, and calculates and formats the parameters for the loading process, i.e. the identification of the various used memory lines and the corresponding use sequences.

The switcher process 27 then determines whether or not each edition, i.e. each track, must be filtered. If so, the switcher process 27 extracts from the file of filters which were sent as parameters the filter(s) related to the track to be filtered, checks the number of inputs/outputs, and then creates as many memory lines as there are outputs for the filter(s) to be applied. The switcher process 27 then prepares and formats the parameters for the filtering process, i.e. the identification of the various audio and video source memory lines and the various destination memory lines of the track.

The switcher process 27 then examines whether or not the track must be displayed. If so, and if the track has also been filtered, the switcher process 27 uses the destination memory lines which were identified for the filtering process. If the track must be displayed, but without filtering, the switcher process 27 sends the previously created audio and video source memory lines to the display process. It should be noted that in this case, the source memory lines also act as destination memory lines. The switcher process 27 then calculates and formats the parameters for the display process (memory lines and use sequences).

The switcher process 27 then determines whether or not the edition flow must be recorded. If so, and if the track has been filtered, the switcher process 27 uses the destination memory lines of the filtering process. If the flow must be recorded without filtering, the switcher process 27 sends the audio and video source memory lines to the recording process. There too, it calculates and formats the parameters for the recording process (memory lines and use sequences).

Acquisition Case:

As a function of the parameters which are received from the application process, the switcher process 27 determines whether the acquisition is displayed and recorded, and calculates the use sequence of the corresponding synchronized buffers.

The parameters are:
a “list of acquisition editions” file (edl acquisition),
a “list of files” file (edl file).

For each edition of the list of editions which is transmitted to the switcher process 27, the latter determines the data format (audio/video standard), and calculates the size of the acquisition edition in relation to the maximum size of the various tracks of each multitrack flow of the sequence to be acquired, in such a way as to determine the percentage of useful areas of the self-administered memory which each memory line can use.

In the case that the switcher process 27 then detects the presence of audio tracks in the list of acquisition editions, it creates an acquisition memory line for each corresponding audio track. Similarly, when the switcher process 27 detects the presence of video tracks in the list of acquisition editions, it creates an acquisition memory line for each corresponding video track.

The switcher process 27 then determines and formats the parameters for the acquisition process, in particular the identification of the various memory lines and their use sequence.

The switcher process 27 then determines whether or not the edition must be displayed. If so, it prepares the corresponding parameters (acquisition memory lines) for the display process. The switcher process 27 then determines and formats the parameters for the recording process.

Steps 53 (analysis) and 54 (creating memory lines) described above are only non-restrictive examples, and many other forms of analysis can be provided, according to the applications of the device according to the invention.

The following step 55 consists of opening a loop on the various flow management processes 28 to 31 which are loaded into memory. For each of these processes, in step 56 a test is carried out to determine whether this flow management process 28 to 31 can be concerned by the track to be processed. If so, the switcher process 57, in step 57, sends the corresponding memory lines and synchronization information (use sequence) to the first concerned flow management process. If not, the process loops back to go to the next flow management process. After step 57, a test 58 is executed to terminate the loop, i.e. to know whether this was the last flow management process of the use sequence. If this is not the case, the process goes to the next flow management process. If it is the case, a test 59 is executed to find out whether the processed track was the last. If not, the process loops back to step 53 to execute steps 54 to 58 again on the next track. If this was the last track, the first phase of analyzing the sequence of multitrack flow(s) to be processed is completed, and the process goes on to a subsequent execution phase, comprising first a step 60 of initializing the switcher process 27, then, in step 61, receiving a command from the user, i.e. from the application program which the user controls (human/machine interface 26), and then, in step 62, an action is sent to each flow management process 28 to 31 to initiate the functioning of these flow management processes, synchronized with each other.

FIG. 6 shows the functional flowchart of a flow management process which is controlled by the switcher process 27. In FIGS. 5 and 6, the links between the two flowcharts are shown by the letters A and B.

Step 63 corresponds to the start of the flow management process, followed by step 64 of attaching this flow management process to the self-administered memory 3, i.e. to the “READY” state shown in FIG. 7.

In the subsequent step 65, the flow management process can receive a list of editions (a sequence of multitrack flows) which is sent to it by the switcher process 27 at the end of step 57 of this switcher process 27. If the flow management process then receives an action in step 66 from the switcher process 27 (following step 62 of sending an action by this switcher process 27), the flow management process opens a step 67 of opening a loop, which makes it possible to run through every track of the list, each corresponding to a memory line. Following this step 67, it executes a step 68 which makes it possible to determine whether or not the requested action and the function which it executes correspond to the creation of one or more synchronized buffers in the useful area 5 of the self-administered memory 3. If not, the flow management process executes a waiting step 69, which is synchronized on a synchronized buffer of the self-administered memory 3. It then executes a test 70 to determine whether the synchronized buffer is or is not available on the source memory line.

It should be noted that the synchronized buffer on which the flow management process positions itself is determined in advance in the memory line by the switcher process 27, and this data is known by the flow management process.

While the synchronized buffer is unavailable as determined by the test 70, the flow management process returns to the waiting step 69. When the synchronized buffer becomes available, the flow management process executes the subsequent step 71 of processing the data in this synchronized buffer.

Also, if the test 68 determines that the flow management process must create a synchronized buffer, step 72 of creating this synchronized buffer is executed, and then the process goes to step 71 of processing the data in the thus created synchronized buffer.

The flow management process creates a synchronized buffer when it is the first flow management process to act on a memory line to be processed. After executing step 71 of processing the data, the flow management process releases the synchronized buffer in step 73, to make it available to the flow management process which must then act on this synchronized buffer. After this step 73 of releasing the synchronized buffer, the flow management process terminates the loop of running through the various flows of the list by virtue of the test 74, which, after having processed all the tracks of the list, executes a step 75 of ending the processing of this list of editions.

The common library 32 makes it possible to define various administration elements which are actually lists, since each administration element contains a reference to the previous and next elements.

An administration element of memory fragment type is further defined by its start offset in relation to the base address of the useful area 5 of the self-administered memory 3, its end offset in relation to the base address of this useful area 5 of the self-administered memory 3, and its size.

An element of memory line or “TRACK” type is further defined by an identifier, a list of synchronized buffers which are associated with it, and its size.

An administration element of memory buffer or “BUFFER” type is further defined by its identifier, its address in memory (offset in relation to the start address of the useful area 5 of the memory), its size, a use sequence (or transition table), and a variable representing its state.

The administration area 4 is divided into administration buffers where the administration elements (memory lines, released memory buffers or released memory fragments) will be defined.

At the time of a request to create a memory line or memory buffer, the administration module 32 converts a released administration element into an element of memory line or memory buffer type.

In the case of a conversion to an element of memory line type, the switcher process 27 defines the use sequence as a function of the processing constraints of the multitrack flow, and in particular according to the various flow management processes which will be necessary for this processing.

In the case of conversion of an element into a memory buffer, the administration module 32 recovers a fragment of the useful area 5 from the list of released memory fragments, as a function of the desired size for this buffer. Three cases are possible:

1) If the released memory fragment is of a size less than the size of the desired memory buffer, the administration module will recover the next released memory fragment and restart the test. If there is no released memory fragment, an error is returned to the creating flow management process (the process then makes multiple successive requests while waiting for an area to be released by another process).

2) If the released memory fragment is of the same size as the desired buffer, the start value of the fragment is assigned to the address value of the memory buffer, and the released memory fragment is deleted from the list of released memory fragments in the administration area 4.

3) On the other hand, if the memory fragment is of a size greater than the size of the desired memory buffer, the start value of the fragment is assigned to the address value of the buffer, and the released memory fragment is reduced by the size assigned to the buffer.

Next, the state of the memory buffer is initialized to the value corresponding to a number which identifies the flow management process which is active on this buffer.

When a synchronized buffer is released by a flow management process, the state will change as a function of the use sequence which is defined for this synchronized buffer (return to the initial state, or go to the next state—this case makes the synchronized buffer available for the next flow management process—or delete the buffer if this was the last flow management process in the use sequence).

If releasing the synchronized buffer implies deleting it, the administration module 32 converts it into a released memory fragment, and it is then added to the list of released memory fragments in the administration area 4. It then defragments the useful area 5 of the memory by checking that the synchronized buffer is or is not adjacent to one or two released memory fragments.

When a flow management process requests access to a synchronized buffer, the following checks are carried out before giving access to the synchronized buffer:
does the memory line exist?
does the synchronized buffer exist?
is the synchronized buffer available for the flow management process (checking its current state)?

If the synchronized buffer is available for this flow management process, the address of the synchronized buffer is returned to the flow management process which can use it. Otherwise, a code indicates the state of the synchronized buffer.

The flow management process has the option of requesting access to a memory buffer asynchronously (useful for a checking process), i.e. it can recover a memory buffer irrespective of its state.

It should be noted that such a method of self-administered memory management, implemented in a device according to the invention, can be implemented in any IT language which supports dynamic allocation of memory and management of shared memory. It should also be noted that the descriptive data which is contained in a memory buffer can vary. For example, the identifiers (memory buffer or memory line) consisting of integers can be replaced by character strings. FIGS. 8 and 9 show an example of a particular application. It should be noted that this example does not strictly correspond to the implementation example which is shown in FIG. 4. In FIG. 8, an example of a timing diagram of two successive audiovisual flows is shown. These are a sequence in MPEG2 format lasting 3 seconds and comprising a video track V1 and an audio track A1, followed by a DV sequence, also lasting 3 seconds, and also comprising a video track V1 and an audio track A1.

FIG. 9 shows schematically the processing of these flows by the self-administered memory 3, in conformity with the invention. The list of editions 90 is supplied to the switcher process 27. In the shown example, the following flow management processes are provided: a loading process PGF1, a video display process PGF4, an audio listening process PGF5, an MPEG2 decompression process PGF2, and a DV decompression process PGF3.

In the shown example, each flow management process uses at least one source memory line and at least one destination memory line. The memory line LMO as source means that the flow management process is the creator of a synchronized buffer (and the first agent of the use sequence) and does not receive data from a memory line (e.g. loading process). Similarly, the memory line LMO as destination means that the flow management process is the last agent of the use sequence on a synchronized buffer.

The switcher process 27 defines, in the administration area 4, using the library 32, six memory lines LM1, LM2, LM3, LM4, LM5, LM6, with in each case its maximum size and start address. For example, the maximum size for memory line LM1 and memory line LM4 is 10% of the useful area 5 of the self-administered memory 3. And the maximum size of the memory lines LM2, LM3, LM5 and LM6 is 20% of the useful area 4 of the self-administered memory 3.

Each flow management process which creates synchronized buffers on a destination memory line also defines synchronized buffers such as TM1, TM2, etc., and records their size, their number, their address, their use sequence and their current state in the administration area 4, all using the library 32.

In the useful area 5 of the self-administered memory 3, the various memory lines LM1 to LM6 and the types of data which are processed there are shown. The synchronization data which is addressed by the switcher process 27 to each of the flow management processes which identify the source and destination memory lines and the synchronization information (use sequences and/or identification of synchronized buffers) is also shown.

In the shown example, the switcher process 27 supplies to the first flow management process (PGF1), which is the loading process, information 95 comprising the number of the source memory line, which is LMO in the example, the number of the destination memory line, and the use sequence of the synchronized buffers of this destination memory line. For the first list of editions (MPEG2 sequence), the destination memory line is LM1 and the use sequence is 1, 2, meaning that the flow management processes PGF1 and PGF2 in succession must act in succession on the data from the memory line LM1 to process this flow. For the second list of editions (DV sequence), the source memory line is LMO, the destination memory line is LM4, and the use sequence is 1, 3, meaning that the processes PGF1 and PGF3 will act in succession.

The loading process PGF1 is a creator of synchronized buffers, since it must load the data of the source memory line into the useful area 5 of the memory. The loading process PGF1 thus creates the necessary synchronized buffers. Typically, in the shown example, thirty synchronized buffers per second of flow must be created. Thus the loading process PGF1 uses ninety synchronized buffers TM1, TM2, TM3, . . . , TM90 in succession for the MPEG2 sequence on the destination memory line LM1. To do this, it creates a first synchronized buffer TM1, loads the data of the MPEG2 sequence into it, and then releases this buffer TM1. The administration module 32 then allows the next active flow management process, i.e. the process PGF2 which carries out the MPEG2 decompression, to act. The loading process repeats these operations in succession on the ninety synchronized buffers TM1 to TM90.

Previously, the switcher process 27 had supplied the information 96 to the next flow management process PGF2. Consequently, this process PGF2 knows that it must act on a source memory line LM1 and on destination memory lines LM2 with the use sequence 2, 4 (PGF2 then PGF4), and LM3 with the use sequence 2, 5 (PGF2 then PGF5), for the synchronized buffers from the synchronized buffer TM1 to the synchronized buffer TM90. Thus this example shows that, by virtue of the invention, multiple flow management processes are active simultaneously on different synchronized buffers, in a perfectly synchronized way.

The process PGF2 can thus use the memory line LM2 for the video track from the MPEG2 flow and the memory line LM3 for the audio track from the MPEG2 flow. It loads and releases the synchronized buffers of these two memory lines in succession with appropriate data, as described above for the process PGF1. The administration module 32 then allows the flow management process PGF4 for video display of the memory line LM2 to use the synchronized buffers as these synchronized buffers are released in succession. It also, in the same way, allows the audio listening process PGF5 to use the buffers of the memory line LM3 in succession.

There too, the switcher process 27 had supplied the information 97 and 98 respectively in advance to these processes PGF4, PGF5. Consequently, these two processes know that the source memory lines LM2 and LM3 must be processed, and that the destination memory line is LMO, which means that these processes PGF4, PGF5 are the last agents on the use sequence corresponding to the MPEG2 flow.

The device according to the invention also makes it possible, in the given example, to read an audio track and a video track simultaneously from an MPEG2 flow, in a perfectly synchronized way.

Additionally, the process PFG1 loads the data into memory while the processes PGF2 and PGF3 read and decompress the data from memory. In fact, it is an advantage of the invention that it enables several processes to use the memory for writing and/or reading simultaneously.

The same type of functioning takes place to process the second flow in DV format. As it is loaded into the synchronized buffers of the memory line LM4 in succession, the use sequence allows the activation of the flow management process PGF3 of DV decompression. The latter receives the data from each synchronized buffer of the memory line LM4 in DV format, and decompresses and loads this decompressed data into the synchronized buffers in succession of the two memory lines LM5 with the use sequence 3, 4 (PGF3 then PGF4) and LM6 with the use sequence 3, 5 (PGF3 then PGF5), video and audio respectively. The switcher process 27 had communicated the information 99 to the flow management process PGF3 to indicate to it the identification of the source and destination memory lines, the use sequences and the numbers of the start and end synchronized buffers (TM91 and TM180).

It should be noted that, with a device conforming to the invention, the synchronized buffers TM1 to TM90 or TM91 to TM180 which are created on the same memory line do not necessarily correspond to contiguous spaces in the useful area 5 of the self-administered memory. The result is much more flexible, efficient management of this useful area 5, the capacity of which is greatly improved relative to previous devices, in which such use of discontinuous buffers for the same process and/or for processing the same data flow is impossible. But the memory lines represent an abstraction of attachment and continuation of the synchronized buffers.

As can be seen, the various flow management processes receive all the synchronization information from the switcher process 27, and do not communicate with each other. They are synchronized from this information and by the administration module 32. Only the flow management processes PGF1, PGF2, PGF3 which create synchronized buffers in the memory lines receive the corresponding use sequences, and record them in the administration area 4 with the memory lines and the identifiers of the corresponding synchronized buffers.

Obviously, the example shown in FIGS. 8 and 9 is not restrictive, and very many other possibilities are offered. For example, two video sequences in non-compressed format can be read simultaneously on the same screen, separated into two distinct parts, using the device according to the invention. It is thus enough to provide one track, e.g. of F1 type, carrying out filtering consisting of superimposing one picture in another and applying a flow management process corresponding to this superimposition simultaneously on the two sequences, which are read in parallel. The switcher process 27 can define three memory lines, that is one source memory line for each of the video sequences to be read, and a third destination memory line to receive the result of the superimposition, which will be supplied to the video display process. Numerous other examples are possible.

1. A device comprising:
means with microprocessor(s) and RAM(s), which are suitable for executing at least one operating system and at least one data processing application program,
at least one virtual RAM, which is suitable for use as working RAM for at least one application program, of which at least one is suitable for processing at least one flow of digital data, called a multitrack flow, comprising multiple tracks which are read and/or written and/or processed in parallel,
wherein:
a) it comprises means, called configuration means, which are suitable for configuring the device with:
a virtual memory area, called the self-administered memory (3), which is reserved and dedicated to the processing of multitrack flows, this self-administered memory comprising an administration area (4) which is dedicated to the administration of the self-administered memory, and a useful area (5) for processing the data,
a functional process, called the switcher process (27), which is suitable for being loaded into RAM, and for defining and recording in the administration area (4) at least one memory line which is intended to contain a list of buffers, called synchronized buffers, of the useful area (5) of the self-administered memory,
multiple functional processes, called flow management processes (28-31; PGF1-PGF5), which are suitable for being loaded into RAM, and, with at least one memory line, for creating and/or using at least one synchronized buffer in this memory line, for executing at least one task on the data of a multitrack flow, and then for releasing this synchronized buffer,
b) the switcher process (27) is suitable for:
determining, as a function of predefined processing constraints for each multitrack flow to be processed, a sequence for using the synchronized buffers of at least one memory line by each flow management process, called an active process, which is involved in the processing of the said multitrack flow,
transmitting to each active process the memory line(s) in which it must create and/or use synchronized buffers,
c) it includes an administration module (32), which is suitable for synchronizing the successive use of the synchronized buffers of each memory line by the active processes, as a function of the use sequence which the switcher process (27) determines.

2. A device as claimed in claim 1, wherein the administration module (32) is linked to the switcher process (27) and to each flow management process, and combines the common management functions of the self-administered memory (3).

3. A device as claimed in one of claims 1 or 2, wherein the administration module (32) is suitable for determining, when a synchronized buffer is released by a flow management process, the subsequent flow management process which is defined in the use sequence, and if none is defined, for deleting the synchronized buffer.

4. A device as claimed in one of claims 1 to 3, wherein each flow management process (28-31; PGF1-PGF5) is suitable for processing the data at each instant with a single synchronized buffer of one memory line, and then for releasing this synchronized buffer at the end of processing, the various synchronized buffers of a memory line being used in succession by each flow management process, one after the other, in such a way that several flow management processes can be active simultaneously on different synchronized buffers.

5. A device as claimed in one of claims 1 to 4, wherein the administration module (32) is a function library which includes the following functions:
creating the administration area (4) and useful area (5) of the self-administered memory (3),
initializing a memory line with a maximum rate of filling the useful area (5) for this memory line,
creating a synchronized buffer in a memory line,
releasing a synchronized buffer,
access to a synchronized buffer by an active process,
determining the subsequent active process in the use sequence of a synchronized buffer of a memory line, after the synchronized buffer has been released by the previous active process.

6. A device as claimed in one of claims 1 to 5, wherein the switcher process (27) is suitable for defining, for each track of each multitrack flow to be processed, at least one memory line which is dedicated to the processing of this track.

7. A device as claimed in claim 6, wherein the switcher process (27) is suitable for defining, for each track of each multitrack flow to be processed and for each flow management process which processes the data of this track, at least one source memory line which supplies data to be processed by the flow management process, and/or at least one destination memory line which receives the data which the flow management process has processed.

8. A device as claimed in one of claims 1 to 7, wherein the switcher process (27) is suitable for defining one and only one use sequence for all the synchronized buffers of the same memory line.

9. A device as claimed in one of claims 1 to 8, wherein the switcher process (27) is suitable for transmitting the use sequence of each memory line to the first flow management process which must be active on a synchronized buffer of this memory line, this flow management process being the creator of this synchronized buffer, and defining and recording, in the administration area (4), data which identifies this synchronized buffer and associates it with the memory line and use sequence.

10. A device as claimed in one of claims 1 to 9, wherein the switcher process (27) is suitable for calculating, as a function of the nature of each multitrack flow to be processed, a maximum size of the useful area (5) of the self-administered memory (3) which can be given to each memory line.

11. A device as claimed in one of claims 1 to 10, wherein the flow management processes (28-31; PGF1-PGF5) are distinct, and each of them carries out at least one task which belongs to it.

12. A device as claimed in one of claims 1 to 11, including at least one application program, called the launcher module, which is suitable for loading into RAM the various processes and modules which make the configuration and functioning of the self-administered memory possible, including:
the switcher process (27),
each flow management process which is liable to be used for processing multitrack flows,
the administration module (32),
a module (26) for dynamic windowing on a display screen of the device, suitable for forming a human/machine interface which enables a user to define each multitrack flow to be processed from source data with various origins.

13. A device as claimed in one of claims 1 to 12, comprising:
at least one flow management process, called the loading process, which is suitable for writing data into the useful area (5) of the self-administered memory,
at least one flow management process, called the unloading process, which is suitable for reading data from the useful area (5) of the self-administered memory.

14. A device as claimed in one of claims 1 to 13, wherein the flow management processes are suitable for being loaded into a RAM area which is distinct from the self-administered memory (3).

15. A device as claimed in one of claims 1 to 14, wherein the switcher process (27) is suitable for being loaded into a RAM area which is distinct from the self-administered memory (3).

16. A device as claimed in one of claims 1 to 15, wherein the switcher process (27) is suitable for:
in a first analysis phase, analyzing the characteristics of each multitrack flow to be processed and the processing constraints of each multitrack flow, in such a way as to define the data representing the memory lines and the data representing each use sequence of the synchronized buffers of each memory line for processing this multitrack flow,
then, in a second, subsequent processing stage, launching the processing of the multitrack flow according to the said data, which was defined in advance in the analysis phase.

17. A device as claimed in one of claims 1 to 16, wherein the size of the self-administered memory (3) is defined by the configuration means at a predetermined fixed value.

18. A device as claimed in claim 17, wherein the size of the self-administered memory (3) is between 20% and 80% of that of the virtual memory.

19. A device as claimed in one of claims 1 to 18, wherein the size of the administration area (4) is defined by the configuration means at a predetermined fixed value.

20. A device as claimed in one of claims 1 to 19, wherein the self-administered memory (3) is defined by the switcher process (27) when it is loaded into RAM.

21. A device as claimed in one of claims 1 to 20, wherein the configuration means are suitable for allowing the processing of multitrack flows which are audiovisual flows.

22. A device as claimed in one of claims 1 to 21, wherein the configuration means are suitable for allowing the processing of multitrack flows having tracks of which the format is chosen from:
high-definition television formats (TVHD),
standard-definition television formats (TVSD),
digital cinema formats,
compressed video formats (MPEG2, MPEG4, DV, etc.),
non-compressed audio formats,
compressed audio formats,
multitrack encapsulation formats,
picture formats,
raw audiovisual data formats.
